(19) United States
(12) Patent Application Publication
(10) Pub. No.: US 2007/0008231 A1
(43) Pub. Date: Jan. 11, 2007

(54) Antenna device using support for portable terminal

(75) Inventors: Hyu-Myung Jeon, Seongnam-si (KR); Dae-Chul Kang, Suwon-si (KR); Yue-Il Youn, Anyang-si (KR); Yu-Jin Chung, Suwon-si (KR); June-Suk Lee, Suwon-si (KR)

Correspondence Address: DILWORTH & BARRESE, LLP, 333 EARLE OVINGTON BLVD., UNIONDALE, NY, 11553, US

(73) Assignee: Samsung Electronics Co., LTD, Suwon-si (KR)

(21) Appl. No.: 11/483,884

(22) Filed: Jul. 10, 2006

(30) Foreign Application Priority Data
Jul. 8, 2005 (KR) 2005-61640

(51) Int. Cl. H01Q 1/24

(52) U.S. Cl. 343/702; 343/895

(57) ABSTRACT

An antenna device for a portable terminal, including a support pivotably disposed on the terminal, which is unfolded from the terminal and rests at an angle for supporting the terminal on a planar surface; and an antenna module disposed on the support. The antenna device is disposed on the support or is formed by the support itself, and receives signals through the support when a user wants to enjoy DMB service. The support is provided in the terminal to avoid a need of a separate portable antenna for DMB service, thereby improving convenience of use. Further, when the support is unfolded from the terminal, the terminal can be placed on the planar surface at a convenient angle for viewing, so that users can enjoy DMB service from a comfortable position.

### PRIORITY

This application claims priority to an application entitled “ANTENNA DEVICE USING SUPPORT FOR PORTABLE TERMINAL” filed in the Korean Industrial Property Office on Jul. 8, 2005 and assigned Serial No. 2005-61640, the contents of which are incorporated herein by reference.

### BACKGROUND OF THE INVENTION

1. Field of the Invention

The present invention relates to a portable terminal, and more particularly to a portable terminal including a separate antenna device for Digital Multimedia Broadcasting (DMB) service provided in a support.

2. Description of the Related Art

In general, a portable terminal is referred to as an instrument providing a peer-to-peer wireless communication function or a client-to-server wireless communication function. Recently, in addition to voice communication service and short message transmission service, portable terminals provide various types of content including mobile banking service, TV service, on-line game service and Video-On-Demand (VOD) service to users.

Such portable terminals may be classified, based on their external shape, as bar-type terminals including input/output devices such as a communication circuit, transmitter and a receiver in a single housing; flip-type terminals including a flip cover mounted on a bar-type terminal; folder-type terminals having a pair of housings opened/closed by pivoting and including input/output devices separately disposed in each housing, or the like. Additionally, many attempts have been made to meet various needs of users while improving portability and convenience of use through sliding-type terminals which have appeared recently, as well as folder-type terminals.

In addition to the above, on-line mobile communication services available through a portable terminal are diversified, with services including game, video file transmission, mobile banking, video-on-demand and digital multimedia broadcasting services. Such diversified mobile communication services result from generalization of portable terminals and various needs of users, followed by commercialization of multiple content service through portable terminals.

Portable terminals have an antenna device in order to ensure at least a predetermined level of reception ratio and communication quality under radio wave conditions varying with the surroundings. Such antenna devices provided for portable terminals have different dimensions (e.g., length) depending on the frequency band to be used by a server.

Such antenna devices may be classified as internal antennas disposed inside the housing of a terminal and external antennas protruding out of the housing. Internal antennas include meander line antennas, loop antennas, inverted L antennas and planar inverted F antennas (PIFA). Additionally, external antennas include whip antennas that have an antenna module, such as a helical antenna, inside an antenna housing, or are disposed so as to be introduced/withdrawn into/from the housing of a terminal. Herein, an antenna housing of an external antenna is one which is exposed to or protrudes from the exterior of the terminal housing.

Because mobile communication services through portable terminals, including voice communication, short message transmission and transception of game/multimedia files, are accomplished by using frequency bands assigned to existing servers (in the case of the U.S., frequency bands of 800 MHz and 1900 MHz), it is possible to ensure at least a predetermined level of reception ratio and communication quality by virtue of an antenna device mounted primarily on a terminal. Further, as DMB service has been commercialized recently, many attempts have been made to provide DMB service through portable terminals.

However, because the frequency band assigned to DMB service is a range of 180-186 MHz or 204-210 MHz, and such frequency bands are different from that used for mobile communication services to date, there is a problem in that it is difficult for users to enjoy DMB service by using conventional antenna devices provided for existing portable terminals. In other words, because a conventional antenna device mounted on a portable terminal is designed to be operated in a frequency band of 800 MHz or higher, it is not suitable for DMB service requiring a frequency band of 180-186 MHz or 204-210 MHz. Moreover, although there is a need for a separate antenna device conformed to the above frequency band for DMB service, the above antenna device for DMB service has a relatively large size compared to a conventional antenna device applied to portable terminals and thus is difficult to utilize in portable terminals.

### SUMMARY OF THE INVENTION

Accordingly, the present invention has been made to solve the above-mentioned problems occurring in the prior art. An object of the present invention is to provide an antenna device for a portable terminal, which is disposed on the terminal to permit users to enjoy DMB service by using a support provided for DMB service.

In order to accomplish this object, there is provided an antenna device for a portable terminal, including a support disposed pivotably on the terminal, which is unfolded from the terminal and rests at an angle for supporting the terminal on a planar surface; and an antenna module disposed on the support.

### BRIEF DESCRIPTION OF THE DRAWINGS

The above and other objects, features and advantages of the present invention will be more apparent from the following detailed description taken in conjunction with the accompanying drawings, in which:

FIG. 1 is a perspective view showing a portable terminal, including an antenna device, according to the present invention;

FIG. 2 is a rear view showing the portable terminal as shown in FIG. 1; and

FIG. 3 is a perspective view showing the support for the portable terminal as shown in FIG. 1.

### DETAILED DESCRIPTION OF THE PREFERRED EMBODIMENT

Hereinafter, preferred embodiments of the present invention will be described with reference to the accompanying drawings. In the following description of the present invention, a detailed description of known functions and configurations incorporated herein will be omitted when it may make the subject matter of the present invention unclear.

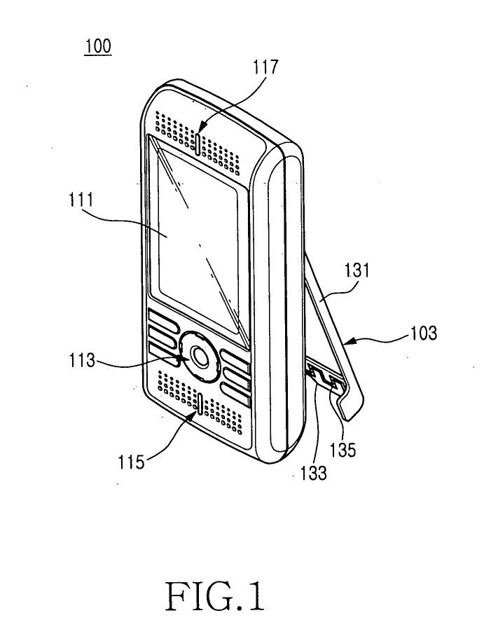

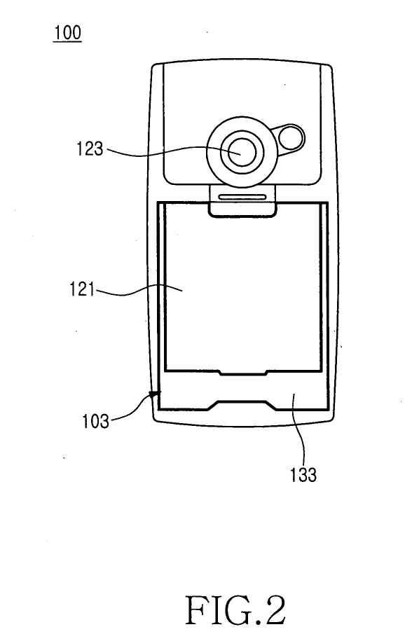

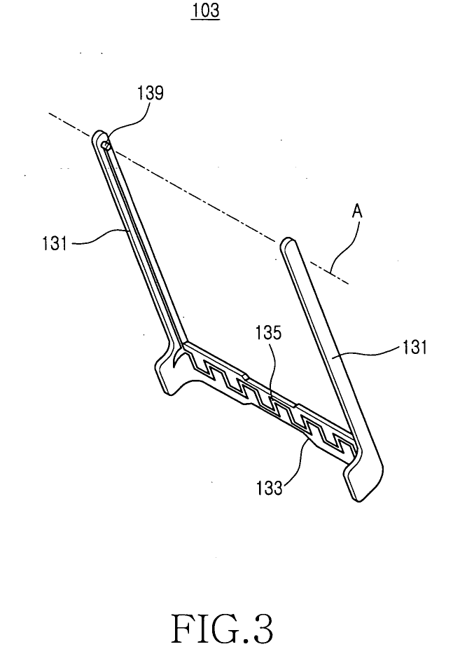

FIG. 1 is a perspective view showing a portable terminal 100 including an antenna device according to the present invention, FIG. 2 is a rear view showing the portable terminal 100 as shown in FIG. 1, and FIG. 3 is a perspective view showing the support 103 of the portable terminal 100 as shown in FIG. 1.

As shown in FIGS. 1 and 2, a display device 111 and keypad 113 are disposed on the front surface of the portable terminal 100, a transmitter 115 is disposed at the bottom of the keypad 113, and a receiver 117 is disposed at the top of the display device 111. Additionally, a battery pack 121 is detachably mounted to the backside of the portable terminal 100, and a camera lens 123 is disposed at one side of the battery pack 121.

The antenna device for general mobile communication of the portable terminal 100 is embedded therein and thus is not shown in the accompanying drawings. The antenna device embedded in the terminal 100 is set with a different frequency from one country to another, according to the communication modes supplied by service providers. In the case of the U.S., frequency bands of 800 MHz and 1900 MHz are assigned to mobile communication servers.

The portable terminal 100 is one capable of satellite or ground wave broadcasting service and includes a support 103, so as to maintain the terminal 100 fixed at a predetermined position when users enjoy DMB service.

Referring to FIG. 3, the support 103 includes a pair of pivotable links 131 and a connection plate 133. One end of each pivotable link 131 is pivotably, coupled to the terminal 100. Additionally, a pivotable protrusion 139 is formed inside the end of the pivotable link 131, so as to be rotatably coupled to the terminal 100. The connection plate 133 connects remaining ends of the pivotable links 131, thereby ensuring structural stability of the support 103.

On the backside of the terminal 100, a pair of slits (not shown) is formed along the longitudinal direction so that the pivotable links 131 can be received in the slits by pivoting on the terminal 100. When the pivotable links 131 are received in the slits, the connection plate 133 is in close contact with the backside of the terminal 100.

Herein, the pivotable links 131 can be pivotably coupled to the terminal 100 through the battery pack 121. In other words, each of the pivotable protrusions 139 disposed at one end of each pivotable link 131 can be pivotably coupled to both sides of the battery pack 121. When the pivotable links 131 are pivotably coupled to the battery pack 121, the slits receiving the pivotable links 131 are formed between the housing of the terminal 100 and both lateral surfaces of the battery pack 121, so that the connection plate 133 can be in close contact with the outer surface of the battery pack 121.

Additionally, the portable terminal 100 is provided with a separate antenna module 135, operating in a frequency band of 180-186 MHz or 204-210 MHz for the purpose of satellite or ground wave DMB service. The antenna module 135 is disposed on the support 103 and connected to a Radio Frequency (RF) board (not shown) of the terminal 100 through the pivotable protrusions 139. Various types of antenna modules 135 may be disposed on the support 103. The antenna module 135, as shown in FIGS. 1 and 3, has an antenna pattern including a conductive material applied to the inner surface of the support 103, particularly to the inner surface of the connection plate 133. The above antenna pattern is advantageous in that it can be modified into various forms so as to conform to characteristics of the antenna device required for the terminal 100. When mounting the antenna module 135 on the support 103, the antenna module 135 preferably takes any one form selected from a meander line antenna and loop antenna. A different form of antenna module can be mounted in addition to the meander line antenna and loop antenna, as long as the antenna module can utilize the space provided by the support 103 or connection plate 133.

The antenna for DMB service, disposed on the portable terminal 100, may include an antenna module formed by manufacturing the support 103 itself with a conductive material instead of the antenna module 135 being disposed on the support 103. When the support 103 serves as an antenna module as described above, there is a possibility of an electric shock caused by electric current leakage through the support 103. Therefore, it is preferable that the support 103 is coated with an insulation material. However, when considering the appearance of the terminal 100, it is relatively difficult to ensure adequate antenna characteristics by using the support 103 itself as an antenna module, compared to using an antenna module having a predetermined pattern. Therefore, when the support 103 itself serves as an antenna module, it is required that a part of the pivotable links 131, or a part of the pivotable links 131 and connection plate 133, be made of a conductive material, so that antenna characteristics required for the terminal can be ensured.

As described above, the antenna device using a support for a portable terminal according to the present invention, which is disposed on the support or is formed by the support itself, receives signals through the support when a user wants to enjoy DMB service. The support is provided in the terminal to avoid a need for a separate portable antenna for DMB service, thereby improving convenience of use. Further, when the support is unfolded from the terminal, the terminal can be placed on a planar surface at a convenient angle for viewing, so that users can enjoy DMB service from a comfortable position.

While the invention has been shown and described with reference to certain preferred embodiments thereof, it will be understood by those skilled in the art that various changes in form and details may be made therein without departing from the spirit and scope of the invention as defined by the appended claims.

What is claimed is:

1. An antenna device for a portable terminal, comprising:
a support pivotably disposed on the terminal, which is unfolded from the terminal and positioned at an angle for supporting the terminal on a planar surface; and
an antenna module disposed on the support.

2. The antenna device for a portable terminal as claimed in claim 1, wherein the antenna module has an antenna pattern formed by a conductive material applied to an inner surface of the support.

3. The antenna device for a portable terminal as claimed in claim 2, wherein the antenna module includes an antenna pattern selected from one of a meander line antenna and loop antenna.

4. The antenna device for a portable terminal as claimed in claim 1, wherein the antenna module is formed by the support itself, the support being made of a conductive material.

5. The antenna device for a portable terminal as claimed in claim 4, wherein the support is coated with an insulation material.

6. The antenna device for a portable terminal as claimed in claim 1, further comprising pivotable protrusions disposed at one end of the support for pivotably coupling the support with the terminal, wherein the pivotable protrusions serve also as connection terminals for connecting the antenna module with a Radio Frequency (RF) board of the terminal.

7. The antenna device for a portable terminal as claimed in claim 1, wherein the support includes a pair of pivotable links each pivotably coupled to the terminal at one end; and a connection plate for connecting remaining ends of the pivotable links with each other.

8. The antenna device for a portable terminal as claimed in claim 7, wherein the antenna module is disposed on the connection plate.

9. The antenna device for a portable terminal as claimed in claim 1, wherein the terminal further includes a battery pack detachably mounted to its backside, wherein the support is pivotably coupled with the battery pack so that the support pivots on the terminal.
